(19) United States
(12) Patent Application Publication
(10) Pub. No.: US 2010/0143869 A1
(43) Pub. Date: Jun. 10, 2010

(54) INTERNAL CONE DENTAL IMPLANT

(75) Inventor: Alejandro Padros Fradera, Barcelona (ES)

Correspondence Address: SUGHRUE MION, PLLC, 2100 PENNSYLVANIA AVENUE, N.W., SUITE 800, WASHINGTON, DC, 20037, US

(73) Assignee: VOGUL, S.L., Andorra (ES)

(21) Appl. No.: 12/301,911

(22) PCT Filed: Apr. 25, 2007
(86) PCT No.: PCT/EP2007/003629

§ 371 Date: Nov. 21, 2008

(30) Foreign Application Priority Data
May 23, 2006 (ES) P 200601408

(51) Int. Cl. A61C 8/00

(52) U.S. Cl. 433/174

(57) ABSTRACT

The invention relates to an internal cone dental implant, of the type that is provided with a blind axial hole comprising a troncoconical section having on its closed end an internally threaded area, designed to receive a dental prosthesis that is adapted to be solidly secured to the head of the implant. The blind axial hole comprises a polygonal prismatic section circumscribed inside the troncoconical section, which is adapted to position and fix the orientation of the prosthesis in relation to the implant, and the outside of the head of the implant comprises a first prismatic end section followed by a second troncoconical section inside which the first section is inscribed, forming an outer support area of the prosthesis. The invention also relates to an assembly consisting of a dental implant, a morphological auxiliary piece and a prosthesis.

### TECHNICAL FIELD OF THE INVENTION

The invention relates to an internal cone dental implant, of the type that is provided with a blind axial hole comprising a troncoconical section having on its closed end an internally threaded area, designed to receive a dental prosthesis that is adapted to be solidly secured to the head of the implant.

The invention also relates to an assembly consisting of a dental implant, a morphological auxiliary piece and a prosthesis.

### BACKGROUND OF THE INVENTION

Internal cone implants are designed to be attached to maxillary bones, their upper end or head having a blind axial hole, comprising a troncoconical section wherein an internally threaded area is often provided, designed for a corresponding stud or bolt that is provided for this purpose in the dental prosthesis to be screwed therein.

When the implant and the bolt are suitably engaged, the prosthesis should rest on a support shoulder provided on the head of the implant, while it must remain adhered to the emerging portion of the bolt, which is generally troncoconical with a decreasing width, called an abutment screw.

However, this type of implant presents a serious tolerance problem, since, however well made the prosthesis, when it rests on the support shoulder, it can be intolerably loose in relation to the abutment screw, or emerging portion of the bolt, or when the prosthesis is firmly positioned on the upper portion of the bolt, it may not rest sufficiently on the support shoulder of the bolt, which can cause problems during mastication cycles, especially when lateral stresses are applied.

Document P200401529 discloses an internal cone implant whose head, in addition to having said axial hole that is adapted to receive a dental prosthesis designed to be solidly secured to the head of the implant, presents an outer profile comprising a first section, increasing in width from the trunk of the implant towards its outer end, and a second unbroken section that forms an outer support area for the prosthesis. Said second section is troncoconical decreasing in width towards the outer end of the head of the implant, which forms the upper end of the head.

The head of said implant is such that the angle formed by the generatrix of said second section with the axis of the implant is between 8° and 30°, preferably between 10 and 20°. Moreover, the height of said support area is between 0.5 mm and 2.5 mm, which, combined with the aforementioned tapering, greatly favours the positioning of the prosthesis on the support area.

It is also known that a dental prosthesis is fitted by first attaching a dental implant to the maxilla or the jawbone and, once it is correctly integrated into the bone, the implant serves as a base for securing the dental prosthesis.

In this regard, there are known dental implants that, in short, consist of a generally cylindrical main body, externally threaded for attachment by screwing to the maxilla or the jawbone, the main body being made from a metal material, preferably titanium. A prismatic protuberance with a polygonal cross-section is preferably positioned on the outer end of said main body, with a threaded axial hole, said protuberance allowing the main body to be screwed using a tool such as a spanner.

Once the dental implant has been fitted in its final position, a threaded pre-prosthetic collar must be fitted to the prismatic protuberance, said collar enabling a threaded bolt that joins the implant and the dental prosthesis to pass therethrough.

For a dental prosthesis to be adequately fitted, especially in the case of a prosthesis that is to replace a single tooth, it is important to take into account both the fitting of the implant in the maxillary bone and the final position of the pre-prosthetic collar on which the prosthesis will be situated in relation to the implant that is inserted into the maxillary bone. When connecting the pre-prosthetic collar to the implant, the collar often rotates in relation to the dental implant that has been fitted, meaning that until now for internal cone or internal cavity implants it has been necessary to use a piece that fits into said cavity and that acts as an anti-rotation device.

Another drawback experienced when fitting dental implants is associated with an insufficient support of the dental prosthesis on the head of the implant, a situation that becomes worse when working with cast prostheses where the measurements and tolerances differ considerably from those that would make the prosthesis fit correctly on the head of the dental implant.

It is therefore clear that there is a need for a dental implant that enables the correct positioning and orientation of prostheses that require a specific position, e.g. angled pieces or preformed pieces, and which also helps to improve the support of dental prostheses on the heads of implants, even in the case of cast prostheses.

### EXPLANATION OF THE INVENTION

The dental implant that is the object of the invention is of the internal cone type that is provided with a blind axial hole comprising a troncoconical section having on its closed end an internally threaded area, designed to receive a dental prosthesis that is adapted to be solidly secured to the head of the implant.

Essentially, the dental implant is characterised in that the blind axial hole comprises a polygonal prismatic section circumscribed in the troncoconical section, which is adapted to position and fix the orientation of the prosthesis in relation to the implant, and in that the outside of the head of the implant comprises a first prismatic end section followed by a second troncoconical section in which the first section is inscribed, forming an outer support area of the prosthesis.

Preferably, the angle formed by the generatrix of the second troncoconical section with the axis of the implant is between 10° and 20°.

According to another characteristic of the invention, the polygonal prismatic section of the blind axial hole and the first prismatic end section of the outer surface of the head of the implant are coaxial prisms whose bases are similar polygons with parallel sides.

According to another characteristic of the invention, the polygonal prismatic section of the blind axial hole and the first prismatic end section of the outer surface of the head of the implant are octagonal prisms.

According to another characteristic of the invention, the outside of the head of the implant comprises an annular troncoconical protuberance whereon the end edges of the prosthesis rest.

According to another characteristic of the invention, the troncoconical section of the blind axial hole is threaded on its open end, which is adapted for securing the prosthesis.

Another aspect of the invention discloses an assembly consisting of a dental implant, a morphological auxiliary piece and a dental prosthesis, characterised in that the dental implant is an implant according to any of the previous claims; and in that the end of the dental prosthesis and the end of the morphological auxiliary piece, which are designed to rest at least partially on the head of the implant, comprise a section whose inner surface is troncoconical and complementary to the second troncoconical section of the head of the implant.

According to another characteristic of the invention, the end of the prosthesis and the end of the morphological auxiliary piece, which are designed to rest at least partially on the head of the implant, respectively comprise an end section subsequent to a complementary section of the second troncoconical section of the head of the implant, wherein the inner surface of the end section is troncoconical and complementary to the annular troncoconical protuberance.

According to another characteristic of the invention, the end of the prosthesis is provided with at least two openings in an opposite direction to the closed end of the blind axial hole and the end of the morphological auxiliary piece is provided with identical openings to those of the prosthesis.

### BRIEF DESCRIPTION OF THE DRAWINGS

The attached drawings show several embodiments of the dental implant and the assembly consisting of the dental implant, morphological auxiliary piece and prosthesis that are the object of the invention. Specifically:

FIG. 1, is an elevation view of a first embodiment of the dental implant according to the invention;

FIG. 2, is a view of the dental implant shown in FIG. 1 sectioned along A-A;

FIG. 3, is a perspective view of the dental implant shown in FIG. 1;

FIG. 4, is an elevation view, in cross-section and in detail, of the head of the dental implant shown in FIG. 1;

FIG. 5, is a plan view of the dental implant shown in FIG. 1;

FIG. 6, is an elevation view of a second embodiment of the dental implant;

FIG. 7, is an elevation view, in cross-section and in detail, of the head of the implant shown in FIG. 6;

FIG. 8, is a plan view of the dental implant shown in FIG. 6;

FIG. 9, is an elevation view of a third embodiment of the dental implant according to the invention;

FIG. 10, is an elevation view, in cross-section and in detail, of the head of the implant shown in FIG. 9;

FIG. 11, is a plan view of the implant shown in FIG. 9;

FIG. 12, is an elevation view of the angled collar of the dental prosthesis of the assembly consisting of the dental implant, morphological auxiliary piece and prosthesis according to the invention;

FIG. 13, is a plan view of the underside of the angled collar shown in FIG. 12;

FIG. 14, is a plan view of the angled collar shown in FIG. 12;

FIG. 15, is a view of the angled collar sectioned along A-A of FIG. 12;

FIG. 16, is a view of detail B of FIG. 12;

FIG. 17, is an elevation view of the assembly consisting of the dental implant and prosthesis joined together;

FIG. 18, is a view of the assembly sectioned along A-A of FIG. 17;

FIG. 19, is a perspective view of two assemblies of dental implants and morphological auxiliary pieces fitted onto the maxillary bone;

FIG. 20, is a view of detail B of FIG. 19; and

FIG. 21, is a side view of the assemblies shown in FIG. 19.

### DETAILED DESCRIPTION OF THE DRAWINGS

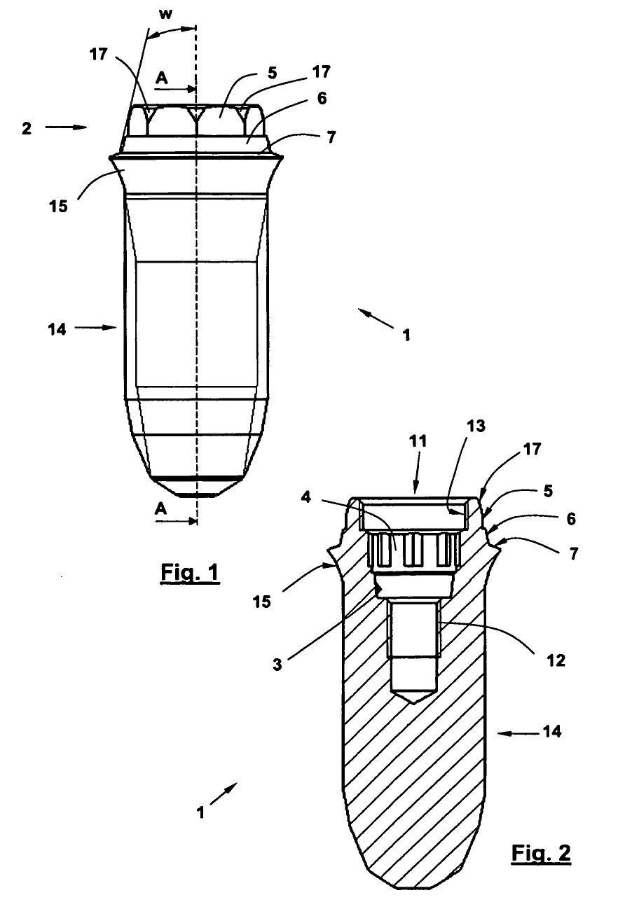

As is shown in FIGS. 1 to 3, the dental implant 1 is essentially cylindrical and elongated, comprising a lower cylindrical section 14 with a threaded outer surface extending along its entire length and enabling it to be secured to the maxillary bone by screwing.

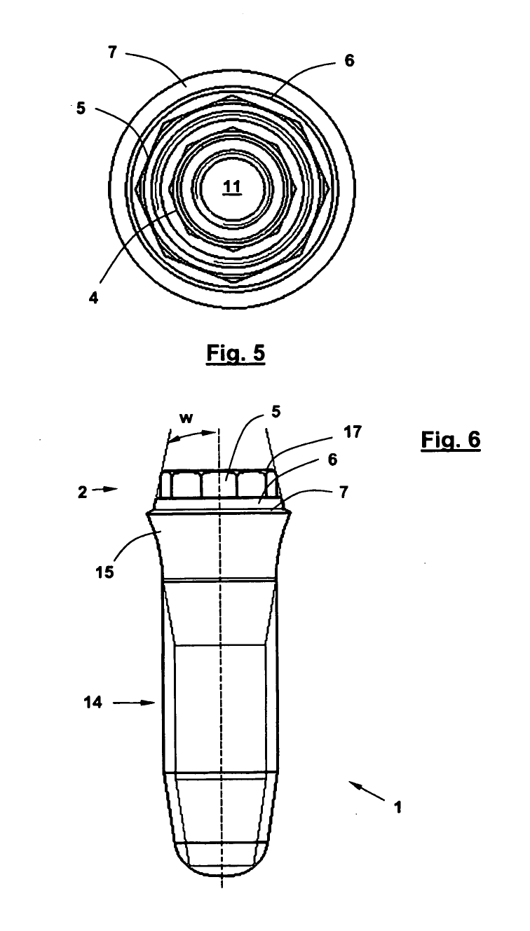

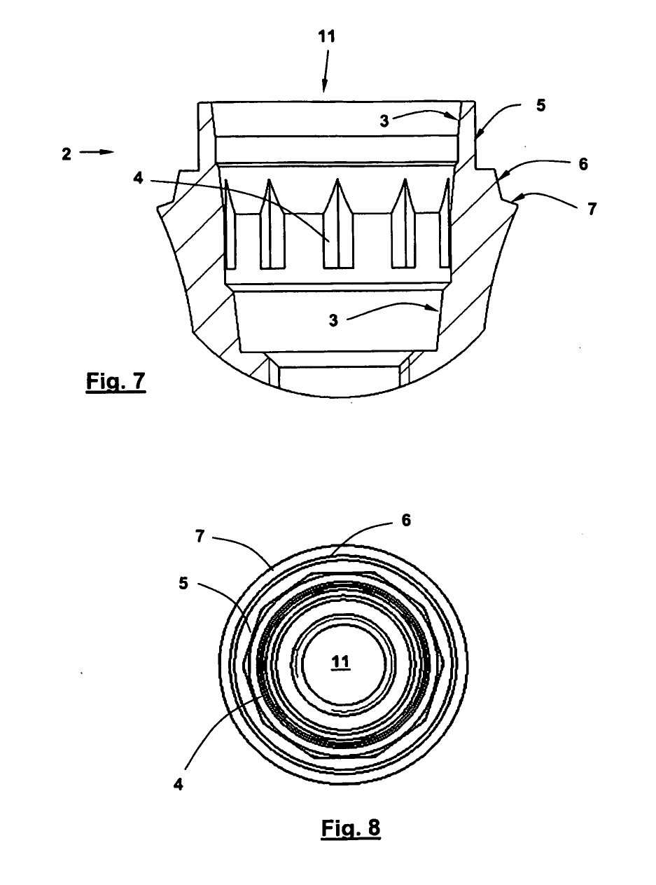

After said lower section 14 there is a troncoconical section 15 that increases in width towards the outer end of the implant; a coaxial annular troncoconical protuberance 7; a second coaxial troncoconical section 6; and finally, on its end, a first coaxial prismatic end section 5 with a polygonal cross-section, which for the implant shown in FIGS. 1 to 5 is a regular octagon and for the implant shown in FIGS. 6 to 8 is a decahedron.

The annular troncoconical protuberance 7 shown in the implants 1 of FIGS. 1 to 8 is the area of maximum diameter, or equator, of the implant 1, which separates the area of the implant 1 that is inserted into the maxillary bone and the emerging area that will be partially covered by gingival tissue.

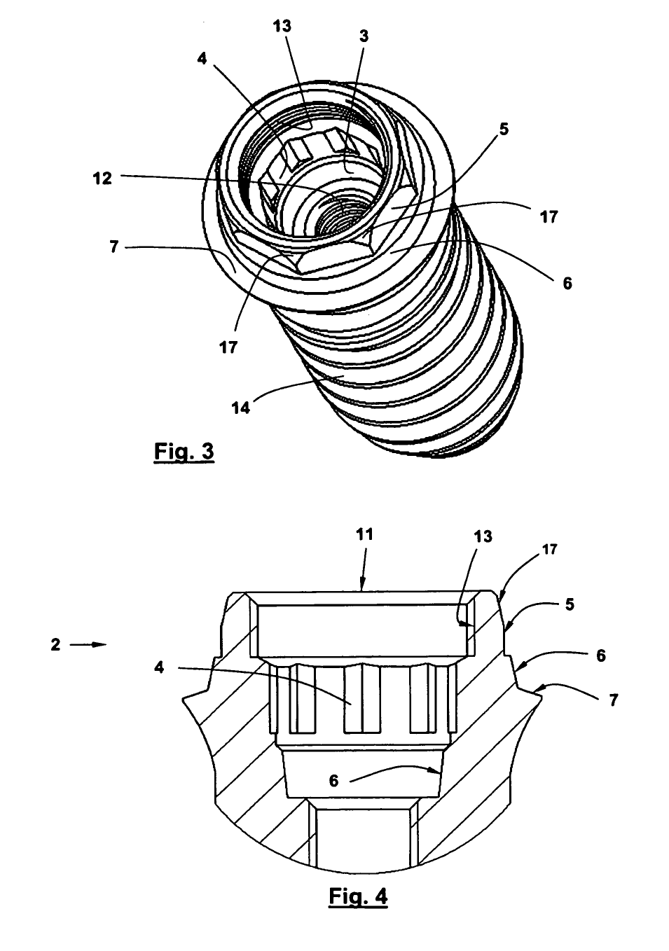

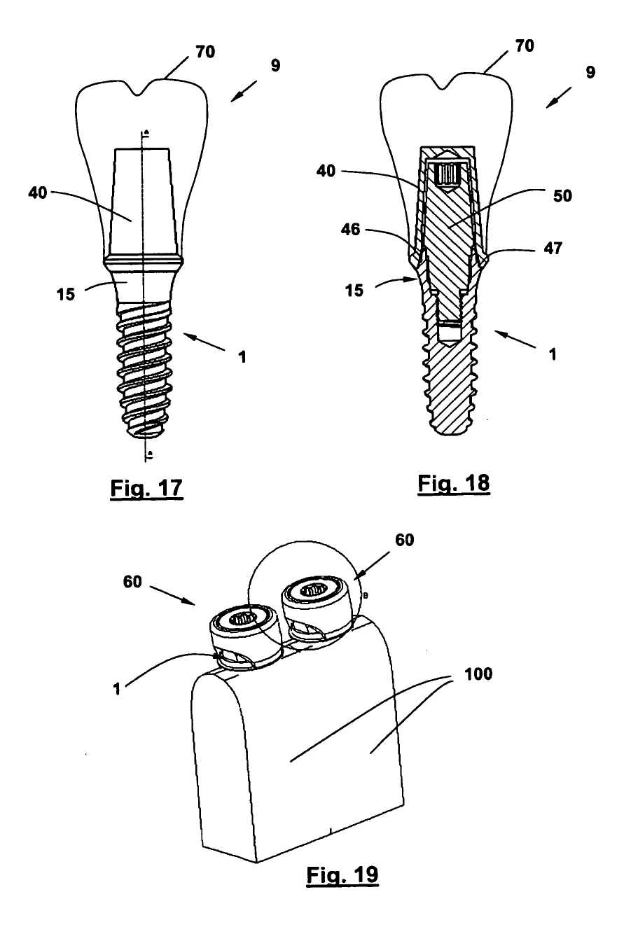

As can be seen in FIGS. 3, 5, and 8, the annular troncoconical protuberance 7 completely surrounds the implant 1 and is bevelled at an angle of approximately 20°. Being peripherally disposed, said protuberance 7 provides better support for fitting cast prostheses, dental prostheses 9 that in turn consist of pre-prosthetic collars 40 on which to position the tooth-shaped moulded piece (see FIGS. 17 and 18), which does not necessarily imply that it must be supported all around the periphery of the protuberance 7, but that the prosthesis 9 may partially rest on the protuberance 7, whilst the areas where it does not rest can be optimised for biological sealing of the gum that occurs in the second troncoconical section 6 after the first session of surgery.

For example, if the dental prosthesis 9 replaces an incisor, the prosthesis 9 will rest on two areas that are diametrically opposed to the annular troncoconical protuberance 7 and/or in the second troncoconical section 6, whilst the other areas that do not receive said support will be covered by the gum, forming papillae in the sections not covered by the prosthesis 9.

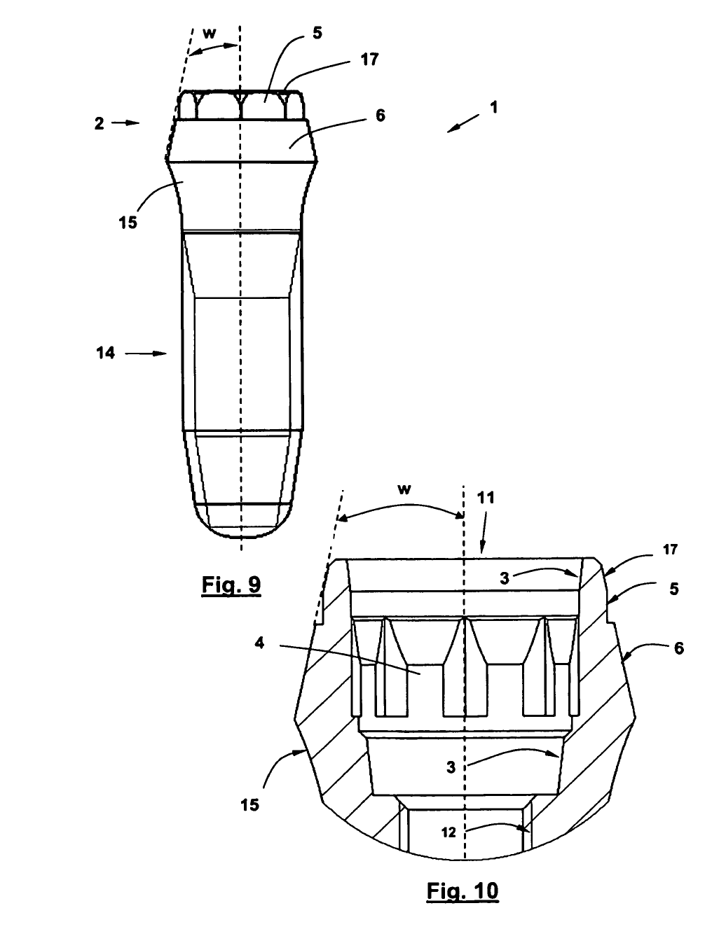

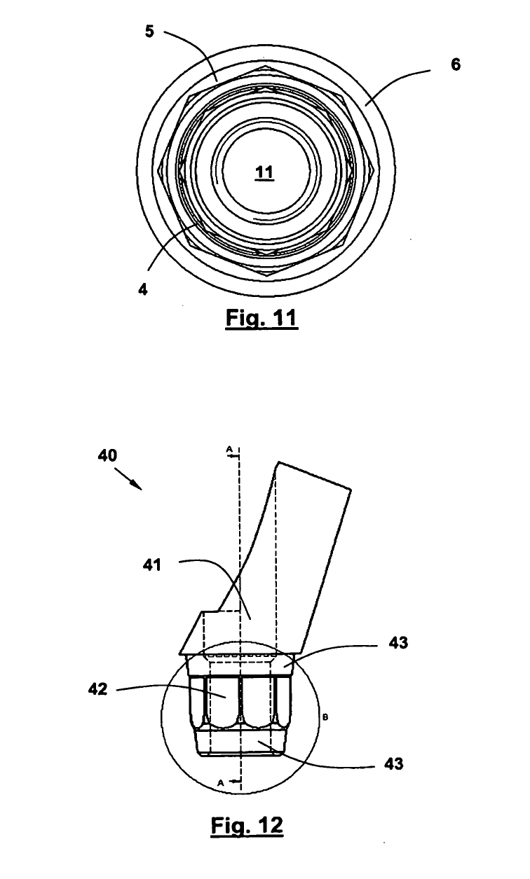

If the implant 1 does not have said annular troncoconical protuberance 7, as is the case with the embodiment shown in FIGS. 9, 10 and 11, the prosthesis will be partially or completely supported on the second troncoconical section 6 of the head 2 of the implant 1, which, in this case, will define the equator of the implant 1.

The dental implant 1 is an internal cone implant in all its embodiments, as it is provided on its upper end with a blind axial hole 11 that, in turn, comprises a troncoconical section 3. In FIG. 2 it can be seen that the blind axial hole 11 is provided with an internally threaded area 12 on its closed end, designed to receive a dental prosthesis 9 that is adapted to be solidly secured to the head 2 of the implant 1.

In FIGS. 2, 4 and 7 it can be seen in detail that the blind axial hole 11 comprises a polygonal prismatic section 4 circumscribed in the troncoconical section 3, which is adapted for positioning and fixing the position of the prosthesis 9 in relation to the implant 1. The troncoconical section 3 of the blind axial hole 11, also called the internal cone, provides stability to all the connections inside the implant 1, thus aiding the insertion and fit of a connecting piece 50 between the implant 1 and the pre-prosthetic collar 40 of the dental prosthesis 9 (see FIG. 18).

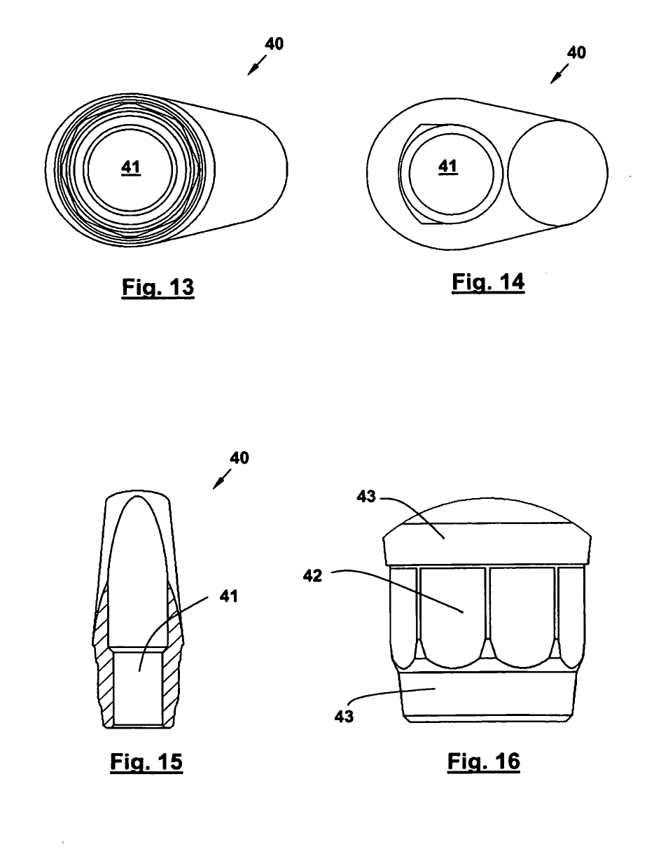

Optionally, the troncoconical section 3 of the blind axial hole 11 can be provided with a threaded area 13 on its open end, as in the implant 1 shown in FIGS. 3 and 4, unlike that of FIGS. 7 and 10 where the upper area of the troncoconical section 3 keeps its shape by not having a threaded area 13. This internally threaded area 13 in the upper area of the internal cone of the implant 1 enables prostheses 9 joined to pre-prosthetic collars with complementary threads on their ends to be secured by screwing, thus directly immobilising the collars in relation to the dental implant 1, a function that would normally be carried out by a bolt that passes through the collar until it is screwed into the internally threaded area at the end of the blind axial hole 11. The pre-prosthetic collars 40 can consist of angled pieces such as those shown in FIGS. 12 to 16 or straight pieces such as that shown in FIGS. 17 and 18.

As was mentioned above, in FIGS. 1, 2, 3, 4, 6, 7 and 9 it can be seen that the outside of the head 2 of the implant 1 comprises a first prismatic end section 5 followed by a second troncoconical section 6, inside which the first section 5 is circumscribed, forming an outer support area for the dental prosthesis 9 (see FIG. 18). The first prismatic end section 5, having a polygonal outer profile that acts as a guide, thus serves to position the prosthesis 9 and prevent it from rotating around the longitudinal axis of the implant 1.

In FIGS. 1, 6, 9 and 10 it can be seen that the angle w formed by the generatrix of the second troncoconical section 6 with the axis of the implant 1 is between 10° and 20°, and is preferably at 12°, the angle that stabilises the prosthesis 9 that rests on said section. The first prismatic end section 5 is situated inside the surrounding cone of said second troncoconical section 6, as can be observed in detail in FIGS. 4 and 7, and the angle of said second section 6 coincides with that of the connecting sections 17 between the adjacent vertical faces that form the walls of the polygonal prism of the first prismatic end section 5. As the first prismatic end section 5 is, in a way, circumscribed inside the second troncoconical section 6, it prevents any type of prosthesis 9 from rotating once it has been fitted.

Preferably, the polygonal prismatic section 4 of the blind axial hole 11 and the first prismatic end section 5 of the outer surface of the head 2 are coaxial prisms whose bases are similar polygons with parallel sides, whether they be hexagons, octagons (FIGS. 1 to 5), decahedrons (see FIGS. 6 to 8), dodecahedrons or any other polygon.

Each of the faces of the polygonal prismatic section 4, which are defined by the sides of the base polygon, forms a specific position of the pre-prosthetic collar 40 through a connecting piece 50 that is inserted into the internal cone of the implant 1, as can be seen in FIG. 18.

Another type of pre-prosthetic collar 40 tends to have an axial hole 41 through which a bolt can pass, which is secured by screwing into the internally threaded area of the closed end of the blind axial hole 11, as is the case of the angled pre-prosthetic collar 40 shown in FIGS. 12 to 16. As can be seen in these figures, the lower half of the angled pre-prosthetic collar 40 comprises a prismatic tab 42 with a polygonal base of a complementary shape to that of the polygonal prismatic section 4 of the head 2 of the implant 1. Thus, when inserted into the polygonal prismatic section 4 circumscribed in the internal cone of the implant 1, said prismatic tab 42 can be situated in as many positions as the base polygon has sides, preventing the angled pre-prosthetic collar 40 from rotating in relation to the implant once inserted. Moreover, it can also be seen from FIGS. 12 and 16 that the prismatic tab 42 ends in a troncoconical section 43 whose angle of taper is complementary to the angle of taper of the troncoconical section 3 of the implant 1, so that the connection between the implant 1 and the angled pre-prosthetic collar 40 is an internal conical connection.

The polygonal prismatic section 4 circumscribed inside the troncoconical section 3 of the blind axial hole 11 is used to screw the implant 1 into the maxillary bone and also to position prostheses that are designed to have a specific position, such as angled or preformed pieces. Furthermore, the internal polygonal formation is used to transfer the shapes and dimensions of the dental prosthesis 9 so that the dental technician can make it.

If the internal cone did not have the internal polygonal formation or irregularity on a prosthesis 9 that is to replace a single tooth, it would be necessary to use a piece that fits into said cavity to prevent it from rotating, as has been the case with conventional cone or internal cavity implants up to now. Similarly, each of the faces of the prismatic end section 5 forms a specific position of the dental prosthesis 9 on the pre-prosthetic collar.

Therefore, thanks to the combination of the internal and external polygonal formation of the inner polygonal prismatic section 4 and the first outer prismatic end section 5, respectively, the internal cone can be more freely used to position and fix the orientation of the prosthesis 9 in relation to the implant 1 and to work with a more suitable piece for the prosthetic situation required in each specific case. This also helps to correct any differences between the insertion axis of the implant 1 and the axis emerging from the prosthesis 9.

FIG. 17 shows an assembly consisting of a dental implant 1 and a prosthesis 9, according to which the prosthesis 9 is designed in such a way that its end rests on at least two diametrically opposing areas of the second troncoconical section 6 and/or the annular troncoconical protuberance 7 (FIGS. 4, 7 and 10).

As has been mentioned above, the annular troncoconical protuberance 7 is designed for the dental prosthesis 9 to rest thereon. Said protuberance 7 is slightly set back from the troncoconical section 15 that is inserted into the maxillary bone, which makes it possible for the end of the prosthesis to rest on the protuberance 7 without laterally projecting from the limit that marks the area of maximum width of said section 15. Thus, even when working with cast prostheses 9, where the accuracy of the measurements tends not to be so exact, the prosthesis 9 will duly rest on the head 2 of the implant 1, as is shown in FIG. 18.

The dental implant 1 may form part of an assembly consisting of itself, a dental prosthesis 9 and a morphological auxiliary piece 60, all of which are connected to one another to replace a dental piece will full guarantees and without any problems of the implant and replacement dental prosthesis 9 not fitting together.

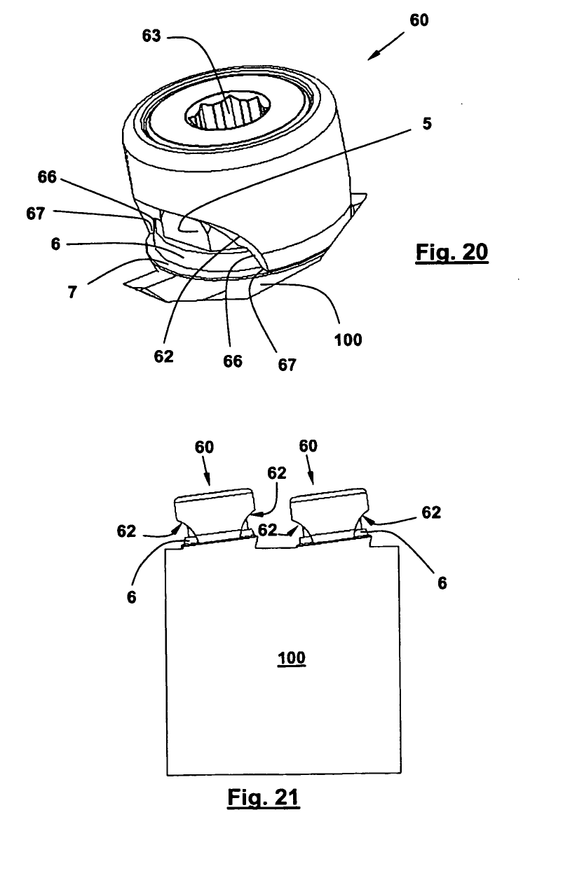

With the aid of FIGS. 19 to 21 a brief explanation will be provided with regard to the operations performed to replace a dental piece by fitting a dental implant 1 according to the invention, starting from the situation in which the defective dental piece has been completely extracted.

Firstly, the dental surgeon fits the dental implant 1 into the maxillary bone, so that the lower edge of the annular troncoconical protuberance 7 marks the equator that separates the emerging part of the implant 1 from the part that is inserted into the maxillary bone and the gum 100 that covers the top of it.

In order to achieve an appropriate healthy final aesthetic appearance, a morphological piece 60 similar to a cap is fitted onto the head 2 of the implant 1. The upper face of the morphological piece 60 is provided with a blind axial hole 63 with a polygonal cross-section to enable the insertion of a tool such as a screwdriver for securing said morphological piece 60 to the head 2 of the implant 1. This is possible because the inside of the morphological piece 60 comprises an externally threaded tab that corresponds to the internally threaded area 13 on the upper area of the internal cone of the implant 1.

It should be mentioned that the lower end of the morphological piece 60 rests on the second troncoconical section 6 and the annular troncoconical protuberance 7 of the head 2 of the implant 1, thanks to the fact that said lower end consists of a troncoconical section 66 complementary to section 6, followed by a troncoconical end section 67 that is complementary to the protuberance 7.

As can be seen in FIGS. 19 to 21, the morphological auxiliary piece 60 is provided with two lateral openings 62 with a curved profile that are diametrically opposed to each other, which are designed to leave open certain areas of the head 2 of the implant 1 that are to be covered by biological gingival tissue of the gum 100. Therefore, some time after the morphological pieces 60 have been fitted onto the implants 1, the biological gingival tissue of the gum 100 will occupy the areas if the head 2 of the implant 1 that were left open.

After a certain length of time, when the morphological pieces 60 are removed for good, it may be observed that the upper edge of the gum 100 has formed curved sections moulded by the profile of said openings 62. This is the moment when the dental prosthesis 9 (consisting of a pre-prosthetic collar 40 on which the tooth-shaped moulded piece 70 is positioned) is fitted, the lower end of which will be similar to the morphological auxiliary piece 60, i.e. with a troncoconical section 46 that is complementary to the section 6, followed by a troncoconical end section 47 that is complementary to the protuberance 7 with the same openings, identically positioned in relation to the implant 1, as the openings 62 in the morphological auxiliary piece 60.

Therefore, when the prosthesis 9 is fitted, the entire periphery of the head 2 of the implant 1 is covered by the prosthesis 9 in some sections and by the gum 100 in the rest, the latter forming papillae between the teeth, which is an undeniable sign of healthy teeth.

It should be taken into account that in FIGS. 19 to 21, the lower ends of the morphological auxiliary pieces 60 have two openings 62, but depending on the type of dental piece to be replaced, a certain shape of papillae of the gum 100 will be required and so, therefore, will a different number and profile of openings 62.

1. Internal cone dental implant (1), of the type that has a blind axial hole (11) comprising a troncoconical section (3) provided on its closed end with an internally threaded area, designed to receive a dental prosthesis (9) that is adapted to be solidly secured to the head (2) of the implant, characterised in that the blind axial hole comprises a polygonal prismatic section (4) circumscribed inside the troncoconical section that is adapted to position and fix the orientation of the prosthesis in relation to the implant, and in that the outside of the head of the implant comprises a first prismatic end section (5) followed by a second troncoconical section (6) inside which the first section is inscribed, which forms an outer support area for the prosthesis.

2. Internal cone dental implant (1) according to claim 1, characterised in that the angle (w) formed by the generatrix of the second troncoconical section (6) with the axis of the implant is between 10° and 20°.

3. Internal cone dental implant (1) according to claim 1 or 2, characterised in that the polygonal prismatic section (4) of the blind axial hole (11) and the first prismatic end section (5) of the outer surface of the head (2) of the implant are coaxial prisms whose bases are similar polygons with parallel sides.

4. Internal cone dental implant (1) according to any of the previous claims, characterised in that the polygonal prismatic section (4) of the blind axial hole (11) and the first prismatic end section (5) of the outer surface of the head (2) of the implant are octagonal prisms.

5. Internal cone dental implant (1) according to any of the previous claims, characterised in that the outside of the head of the implant comprises an annular troncoconical protuberance (7) whereon the end edges of the prosthesis (9) rest.

6. Internal cone dental implant (1) according to any other the previous claims, characterised in that the troncoconical section (3) of the blind axial hole (11) is threaded on its outer end, being adapted to secure the dental prosthesis (9).

7. Assembly consisting of a dental implant (1), a morphological auxiliary piece (60) and a dental prosthesis (9), characterised in that the dental implant is an implant according to any of the previous claims; and in that the end of the dental prosthesis and the end of the morphological auxiliary piece, which are designed to rest at least partially on the head (2) of the implant, comprise a section (46; 66) whose inner surface is troncoconical and complementary to the second troncoconical section (6) of the head of the implant.

8. Assembly consisting of a dental implant (1), a morphological auxiliary piece (60) and a dental prosthesis (9) according to claim 7, characterised in that the dental implant is an implant according to claim 5 or 6 and in that the end of the dental prosthesis and the end of the morphological auxiliary piece, which are designed to rest at least partially on the head (2) of the implant, respectively comprise an end section (47; 67) after section (46; 66), which is complementary to the second troncoconical section (6) of the head of the implant, wherein the inner surface of the end section is troncoconical and complementary to the annular troncoconical protuberance (7).

9. Assembly consisting of a dental implant (1), a morphological auxiliary piece (60) and a prosthesis (9) according to claim 7 or 8, characterised in that the end of the prosthesis is provided with at least two openings in an opposite direction to the closed end of the blind axial hole (11) and in that the end of the morphological auxiliary piece is provided with openings (62) identical to those of the prosthesis.
